(19) United States
(12) Patent Application Publication
(10) Pub. No.: US 2007/0218333 A1
(43) Pub. Date: Sep. 20, 2007

(54) Metal-Oxide Containing Substrate and Manufacturing Method Therefor

(76) Inventor: Kazuya Iwamoto, Osaka (JP)

Correspondence Address: MCDERMOTT WILL & EMERY LLP, 600 13TH STREET, NW, WASHINGTON, DC, 20005-3096, US

(21) Appl. No.: 11/578,072

(22) PCT Filed: Mar. 30, 2005
(86) PCT No.: PCT/JP05/06056

§ 371 Date: Oct. 12, 2006

(30) Foreign Application Priority Data
Apr. 12, 2004 (JP) 2004-117191

(51) Int. Cl. H01M 6/18

(52) U.S. Cl. 429/30; 29/623.1; 428/577

(57) ABSTRACT

A metal-oxide containing substrate including: an alloy including Fe and Cr and including at least one selected from the group consisting of Ni, Mo, Mn, Al and Si; an oxide of a metal element forming the alloy, wherein a powder X-ray diffraction pattern of the substrate observed by using Cu Kα radiation has at least one peak attributed to the oxide.

### TECHNICAL FIELD

The present invention relates mainly to a substrate for carrying a thin film, and to be specific, the present invention relates to a metal-oxide containing substrate comprising an alloy and excellent in resistance to a high-temperature, oxidizing atmosphere.

### BACKGROUND ART

For substrates for carrying a thin film, conventionally, a substrate of silicon such as single crystal silicon, polycrystal silicon, and amorphous silicon is commonly used. However, recently, there is a tendency of shifting from silicon substrates to glass substrates, plastic substrates, and metal substrates.

Generally, thin films are formed under a significantly high temperature. However, glass substrates that are durable under high temperatures are generally expensive. On the other hand, cheap glass substrates lack heat-resistance, and are unable to endure the high temperature at the thin film formation. Further, glass substrates are less shock-resistant, fragile, and not flexible. Also, although plastic substrates are excellent in flexibility, plastic substrates are low in heat-resistance, and are incapable of enduring high temperatures as mentioned in the above. Therefore, cheap, flexible, and comparatively highly heat-resistive metal substrates are gaining attention.

For substrates for carrying a thin film, for example, the following substrates have been proposed.

Patent Document 1 has proposed, as a substrate for carrying a thin film battery, a substrate comprising silicon, quartz, sapphire, alumina, and a polymer. On the substrate, first, a metal current collector is formed, and on the current collector, a positive electrode comprising vanadium oxide is formed. The positive electrode is made, for example, by a sputtering method setting the substrate temperature to 400° C. Afterwards, a solid electrolyte is formed on the positive electrode. Then, metallic lithium is formed on the electrolyte, thus completing a thin film battery.

In Patent Document 1, the positive electrode comprising vanadium oxide is formed under vacuum. Thus, the substrate is not oxidized. A polymer substrate with a low heat-resistance such as polyimide film has been proposed as well. However, to obtain a thin film battery that provides a large current, the crystallinity of the positive electrode has to be improved by annealing the positive electrode thin film under high temperatures. In such case, the polymer substrate cannot be used. Also, the substrate comprising silicon, quartz, sapphire, or alumina has limitation in view of decreasing the thickness.

Patent Document 2 proposes a zirconium substrate with zirconium oxide on the surface thereof, as a substrate for carrying a thin film battery. Zirconium has a high melting point, and therefore a step of annealing the positive electrode thin film to improve the crystallinity of the positive electrode can be carried out. However, when the zirconium substrate is made thin, since zirconium oxide easily allows diffusion of oxygen ions under high temperatures, zirconium is entirely oxidized to zirconium oxide, thereby making the substrate brittle.

Zirconium oxide is formed on the zirconium substrate by an annealing process in which the positive electrode is crystallized. That is, after forming the positive electrode current collector and the positive electrode on the zirconia substrate, zirconium oxide is formed simultaneously with the annealing to improve the crystallinity of the positive electrode. However, in this method, oxygen shortage is caused at the interface between the current collector and the substrate, which makes the formation of zirconium oxide insufficient, and causes the current collector to be alloyed with zirconium. As a result, the electrical resistance of the current collector changes, leaving a concern that variations in charge and discharge characteristics of a battery are caused. Additionally, there may be a case in which electrical conduction is made between the positive electrode and the substrate.

Patent Document 3 proposes a stainless steel substrate as a substrate for carrying a thin film battery. On the stainless steel substrate, first of all, a vanadium oxide solution is applied. Then, the substrate is heated under a temperature in the range of an ambient temperature to 150° C. for 0.1 to 2 hours, thus making a positive electrode thin film comprising vanadium oxide on the substrate. Although the deterioration of the stainless steel substrate does not proceed during the heating under such low temperatures and for a short period of time, a high voltage and a high energy density cannot be expected for the thin film battery to be obtained.

Patent Document 4 proposes a substrate comprising a stainless steel plate or a cold-rolled steel plate, with a compression-bonded layer comprising nickel, aluminum, or the like having a thickness of 200 μm or less on one side or both sides thereof.

Patent Document 5 proposes a composite substrate, in which an aluminum plate or an aluminum alloy plate and a stainless steel plate with high heat-resistance and high elasticity are bonded by pressure, in view of preventing the deformation by heating of the aluminum substrate.

Patent Document 6 proposes a stainless steel plate for a substrate for carrying a silicon thin film. For example, a direct growth of the silicon thin film on the substrate with a temperature of 600° C. by a CVD method is proposed.
Patent Document 1: U.S. Pat. No. 5,338,625
Patent Document 2: U.S. Pat. No. 6,280,875
Patent Document 3: Japanese Laid-Open Patent Publication No. Hei 4-121953
Patent Document 4: Japanese Examined Patent Publication No. Hei 4-78030
Patent Document 5: Japanese Laid-Open Patent Publication No. Sho 62-49673
Patent Document 6: Japanese Laid-Open Patent Publication No. 2003-51606

### DISCLOSURE OF THE INVENTION

### Problem To be Solved by the Invention

With recent downsizing and performance advancement of devices, downsizing or decrease in thickness has been strongly demanded for thin film devices. For example, downsizing and performance advancement are strongly desired for thin film batteries, which are the power sources for small devices. Nowadays, small thin film batteries have been applied also to an RFID tag and IC card, that allow bidirectional communication, and drastically expanding communication distance.

As in the field of thin film batteries, the more downsizing or decrease in thickness is demanded for the thin film device to be carried, the more the substrate has to be made thinner. As mentioned above, although the metal substrate comprising stainless steel and the like is gaining attention as a substrate for carrying a thin film, in a thinner metal substrate, its rigidity is decreased. Thus, upon heat-processing, difference in a coefficient of expansion between the thin film and the substrate, and a residual stress inside the substrate cause warpage and twist of the substrate, to deform the substrate. Such deformation sometimes causes a separation of the thin film from the substrate. Particularly, because the thin film has to be exposed to a high-temperature, oxidizing atmosphere along with the substrate when an improvement in the crystallinity of the thin film is demanded, such problems are significant.

For example, the substrates using the stainless steel as proposed in Patent Documents 4 to 6 deform when exposed to a high-temperature, oxidizing atmosphere. Also, the thinner the substrate, the greater the degree of the deformation. Further, as in Patent Documents 4 and 5, when the aluminum plate or the aluminum alloy plate and the stainless steel plate are bonded by pressure, at a temperature of 600° C. or more, brittle intermetallic compounds such as Al₃Fe and Al₅Fe₂ are produced by reactions between aluminum and iron in the stainless steel. Therefore, a problem of separation at an interface between aluminum and stainless steel is also caused.

As mentioned above, although a substrate for carrying a thin film is required to have resistance to deformation when exposed to a high-temperature, oxidizing atmosphere, none of the conventionally proposed metal substrate satisfies such requirement. The present invention is made in view of the above, and aims to provide a substrate which is excellent in resistance to a high-temperature, oxidizing atmosphere, and hardly deforms even formed thin.

Additionally, when the thin film is formed directly on the substrate, a transition element in the stainless steel plate sometimes diffuses into the thin film. For example, in Patent Document 6, upon growing a silicon thin film on the substrate at 600° C. by the CVD method, a transition element in the stainless steel plate sometimes diffuses into the silicon thin film, deteriorating the characteristics of the silicon thin film. Also, when a nickel layer is bonded on the stainless steel plate by pressure as in Patent Document 4, nickel sometimes diffuses into the silicon thin film. The present invention also aims to prevent such diffusion of an element from the substrate to the thin film.

### Means for Solving the Problem

A metal-oxide containing substrate of the present invention includes an alloy and an oxide of a metal element forming the alloy, wherein the alloy includes Fe and Cr, and includes at least one selected from the group consisting of Ni, Mo, Mn, Al and Si, and a powder X-ray diffraction pattern of the substrate observed by using Cu Kα radiation includes at least one peak attributed to the oxide. The powder X-ray diffraction pattern is determined using the substrate as it is by using a powder X-ray diffraction device.

In the powder X-ray diffraction analysis, for example, peaks attributed to an oxide of Fe and/or an oxide of Cr can be observed. At the same time, at least one peak attributed to an element in a metal state can be observed.

To be more specific, a portion of the metal elements forming the alloy forms an oxide other than a natural oxide film (passivation film) which is usually formed spontaneously at least on a surface portion of the substrate. On the surface of the alloy including Fe and Cr, usually, a passivation film with a thickness of below 10 nm (generally about 3 nm) is formed, but the peak attributed to the passivation film cannot be observed by the powder X-ray diffraction analysis using Cu Kα radiation. On the other hand, in the powder X-ray diffraction analysis of the metal-oxide containing substrate of the present invention using Cu Kα radiation, at least one peak attributed to an oxide can be observed clearly.

The oxide of the metal element forming the alloy preferably exists in a region of the substrate from a surface to a depth of at least 1 μm, and may exist in a further deeper region. The existence of the oxide in a region of the substrate from a surface to a predetermined depth may be examined, for example, by an XPS (X-ray Photoelectron Spectroscopy) or SIMS (Secondary ion mass spectrometry).

The Cr content relative to a total of all metal elements contained in the substrate is preferably 12 wt % or more and 32 wt % or less, and further preferably 16 wt % or more and 20 wt % or less. The Cr content of less than 12 wt % may not ensure sufficient resistance to a high-temperature, oxidizing atmosphere, and of over 32 wt % renders the substrate brittle and apt to crack.

On a surface of the metal-oxide containing substrate, a ceramic layer is preferably formed. For the ceramic layer, for example, at least one selected from the group consisting of a silicon oxide, an aluminum oxide, and a zirconium oxide may be used.

By providing the ceramic layer on a surface of the metal-oxide containing substrate, a reaction between the substrate and a thin film on the substrate that occurs during the heating step can be prevented. For example, when a platinum thin film is formed directly on the metal-oxide containing substrate by a sputtering method and this substrate is heated with a temperature of about 800° C., the electron conductivity of the platinum thin film declines. On the other hand, when a ceramic layer is formed on the substrate and a platinum thin film is formed on the ceramic layer, the decline in electron conductivity of the platinum thin film is prevented.

The present invention also relates to a method for manufacturing a metal-oxide containing substrate, the method comprising a step of: heating a material sheet comprising an alloy including Fe and Cr and including at least one selected from the group consisting of Ni, Mo, Mn, Al and Si in an oxygen-existing atmosphere to convert a portion of a metal element forming the alloy into an oxide.

The heating of the material sheet has to be carried out in an oxygen-existing atmosphere. When the material sheet is heated under an environment without sufficient oxygen supply, the oxidation of the material sheet does not proceed sufficiently, and a substrate excellent in resistance to a high-temperature, oxidizing atmosphere cannot be obtained.

For the material sheet, a stainless steel foil may be used. For the stainless steel, any of austenite-type, ferrite-type, and martensite-type may be used.

The heating of the material sheet is preferably carried out at 400° C. or more and 1000° C. or less, and further preferably carried out at 500° C. or more and 900° C. or less. When the heating temperature of the material sheet is less than 400° C., a metal-oxide containing substrate having sufficient resistance to a high-temperature, oxidizing atmosphere may not be obtained, and when the heating temperature exceeds 1000° C., the substrate may melt and the oxidation may advance excessively to cause an embrittlement of the substrate.

The Cr content relative to a total of all metal elements included in the material sheet is preferably 12 wt % or more and 32 wt % or less, and further preferably 16 wt % or more and 20 wt % or less.

Heating of a thin material sheet with a thickness of below 50 μm is preferably carried out while applying a tension to the material sheet. Since the material sheet went through a rolling step at the time of manufacturing therefor, it has residual stress. This residual stress may cause the substrate deformation while heating the material sheet. However, by applying a tension while heating to the material sheet, such deformation of the substrate can be prevented.

The tension may be applied to an arbitrary direction parallel to the material sheet surface, but preferably, the tension is applied parallel to the rolling direction of the material sheet at the time of manufacturing therefor. The method for applying the tension to the material sheet is not particularly limited. Any method can be used as long as the sheet while heating can keep its original shape. For example, the ends of the material sheet can be fixed with jigs, and with the jigs, a tension in the direction parallel to the material sheet surface may be applied to the material sheet.

In the case of a thick material sheet with a thickness of 50 to 200 μm, a tension does not have to be applied to the material sheet under the manufacturing conditions of the metal-oxide containing substrate proposed in the present invention, that is, under the temperature range of 400° C. or more and 1000° C. or less. This is because, although the thick material sheet also has residual stress from the rolling step at the time of manufacturing therefor, sufficiently thick material sheet relative to the metal oxide layer formed on the surface portion of the substrate does not cause the deformation while heating.

The present invention also relates to a method for manufacturing a metal-oxide containing substrate, the method further comprising a step of: forming a ceramic layer on a surface of the substrate obtained by the heating. Here also, for example, a ceramic layer including at least one selected from the group consisting of a silicon oxide, an aluminum oxide, and a zirconium oxide can be formed.

The ceramic layer may be formed by a resistance-heating deposition method, an electron-beam deposition method, a sputtering method, a sol-gel method, a pulse laser deposition method, and an ion plating method. Two or more of these methods can be combined to form the ceramic layer. In view of economies of mass production and cost reduction, the sol-gel method is the most preferable.

The present invention further relates to an all-solid state battery including the above metal-oxide containing substrate and a power generating element formed thereon, wherein the power generating element includes a positive electrode, a negative electrode, and a solid electrolyte interposed between the positive electrode and the negative electrode.

### Effect of the Invention

A metal-oxide containing substrate of the present invention is highly resistant to a high-temperature, oxidizing atmosphere. That is, the present invention provides a substrate having dimensional stability or shape stability that can endure an annealing under a high-temperature, oxidizing atmosphere even when it is thin. Therefore, the substrate of the present invention hardly causes deformations such as twisting and warpage, and hardly causes a separation of the thin film carried on the substrate. Also, in a further preferable embodiment of the present invention, a thin film is formed on the substrate with particularly excellent condition without deterioration of its characteristics. Additionally, since the thickness of the substrate carrying a thin film device can be decreased, the present invention is advantageous in downsizing and thinning of the device itself and of appliances to which the device is mounted.

### BRIEF DESCRIPTION OF THE DRAWINGS

FIG. 1 An X-ray diffraction pattern of a metal-oxide containing substrate according to an Example of the present invention.

FIG. 2 An X-ray diffraction pattern of a material sheet used in an Example of the present invention.

FIG. 3 A cross section of an all-solid state thin film battery according to an Example of the present invention.

FIG. 4 A diagram showing a relationship between battery voltage and capacity of an all-solid state thin film battery according to an Example of the present invention.

### BEST MODE FOR CARRYING OUT THE INVENTION

A metal-oxide containing substrate of the present invention includes an alloy and an oxide of a metal element forming the alloy, wherein the alloy includes Fe and Cr as main components, and includes at least one selected from the group consisting of Ni, Mo, Mn, Al and Si as a sub-component. A portion of the metal element forming the alloy forms an oxide different from a usually-formed passivation film at least on a surface portion of the substrate.

The existence of the oxide different from the passivation film can be confirmed by a powder X-ray diffraction analysis. For example, a powder X-ray diffraction pattern of the substrate using Cu Kα radiation has at least one peak attributed to the oxide. Usually, in a powder X-ray diffraction pattern, a plurality of peaks attributed to an oxide are observed, and in many cases, a peak attributed to an oxide of Fe, and a peak attributed to an oxide of Cr can be observed.

The powder X-ray diffraction pattern has at least one peak attributed to an element in metal state. Usually, in a powder X-ray diffraction pattern, at least a peak attributed to Fe in metal state or a peak attributed to Cr in metal state can be observed. When the peak attributed to an element in metal state cannot be observed, or the peak is excessively small, flexibility of the substrate may become insufficient.

As long as the peak attributed to an oxide and the peak attributed to Fe or Cr in metal state are clearly shown, regardless of the peak intensity, the substrate can be used as the substrate of the present invention. However, in view of a balance between resistance to a high-temperature, oxidizing atmosphere and flexibility in the substrate, the maximum peak intensity (height) in the peaks attributed to an oxide is preferably 3% or more and 95% or less of the maximum peak intensity (height) in the peaks attributed to an element in metal state, and further preferably 10% or more and 95% or less.

The powder X-ray diffraction pattern of the substrate is determined by using a powder X-ray diffraction device, and by using Cu Kα radiation at 2θ/θ. When the powder X-ray diffraction analysis is carried out, an oxide layer with a thickness of several nanometers such as a passivation film formed on the metal surface is not detected. The powder X-ray diffraction analysis is effective in detecting an oxide layer having a thickness on the order of micrometers.

A powder X-ray diffraction analysis is effective in detecting an oxide layer having a thickness on the order of micrometers since the X-ray enters deeper into the sample, unlike a grazing incidence asymmetrical X-ray diffraction method or a thin film X-ray diffraction method, in which an incident angle of the X-ray to the sample surface is made very small to acquire information only on the surface by introducing the X-ray only to the sample surface.

The Cr content relative to a total of all metal elements included in the substrate is preferably 12 wt % or more and 32 wt % or less, and further preferably 16 wt % or more and 20 wt % or less. The Cr content of less than 12 wt % may not achieve sufficient resistance to a high-temperature, oxidizing atmosphere, and of over 32 wt % renders substrate fragile and apt to crack. The total content of the metal elements included in the substrate, excluding Fe and Cr, is preferably 0.01 wt % or more and 20 wt % or less.

The present invention is particularly effective in obtaining a metal-oxide containing substrate with a thickness of 200 μm or less. This is because the metal-oxide containing substrate of the present invention has, for example, a heat-resistance to a temperature of 500° C. or more, and appropriate flexibility, even though the thickness thereof is 200 μm or less. On the other hand, in the case of a substrate comprising a silicon wafer, alumina, quartz, and sapphire, with the thickness of 200 μm or less, both the heat-resistance to a temperature of 500° C. or more and the flexibility probably cannot be achieved at the same time.

The metal-oxide containing substrate of the present invention can be obtained, for example, by heating a material sheet comprising an alloy including Fe and Cr and including at least one selected from the group consisting of Ni, Mo, Mn, Al and Si, in an oxygen-existing atmosphere. For the alloy including Fe and Cr, and including at least one selected from the group consisting of Ni, Mo, Mn, Al and Si, stainless steel is preferably used, since it can be obtained easily. For the stainless steel used in the present invention, stainless steel such as austenite-type, ferrite-type, and martensite-type may be mentioned.

For the austenite-type stainless steel, SUS (Steel Used Stainless) 304 type may be mentioned. For such type of the stainless steel, SUS301, SUS301L, SUS630, SUS631, SUS302, SUS302B, SUSXM15J1, SUS303, SUS303Se, SUS304L, SUS304J1, SUS304J2, SUS305, SUS309S, SUS310S, SUS316, SUS16L, SUS321, and SUS347 may be mentioned. The austenite-type stainless steel has high ductility, excellent toughness, and excellent resistance to corrosion, and its performance is excellent under a low temperature to a high temperature.

For the ferrite-type stainless steel, SUS430 type may be mentioned. For such type of the stainless steel, SUH409, SUH409L, SUH21, SUS410L, SUS430F, SUS430LX, SUS430J1, SUS434, SUS436L, SUS444, SUS436J1L, SUSXM27, and SUS447J1 may be mentioned. Since the ferrite-type stainless steel is barely hardened by a heating process, it is preferably used in the case when the flexibility of the substrate is considered important.

For the martensite-type stainless steel, SUS410 type may be mentioned. For such type of the stainless steel, SUS410S, SUS410F2, SUS416, SUS420J1, SUS420J2, SUS420F, SUS420F2, and SUS431 may be mentioned. Although the martensite-type stainless steel is easily hardened by a heating process, since it has high strength and excellent heat-resistance, it is preferably used when strength and heat-resistance are regarded important.

All of the above symbols showing the kinds of the stainless steel are known to those in the art and used by Japanese Industrial Standards (for example, JIS-G4304, and JIS-G4305), and Japan Stainless Steel Association.

By heating a material sheet in an oxygen-existing atmosphere, gradually from the surface of the material sheet, a portion of the metal elements forming the alloy is converted to an oxide. Therefore, in many cases, distribution of the oxide gradually decreases from the substrate surface to the center.

The heating of the material sheet has to be carried out in an oxygen-existing atmosphere. In an environment without sufficient oxygen supply to the material sheet, oxidation of the material sheet does not proceed sufficiently even though the heating is carried out, and a substrate excellent in resistance to a high-temperature, oxidizing atmosphere cannot be obtained. The partial pressure of oxygen in the oxygen-existing atmosphere is preferably 0.5 Pa to 100 kPa, and further preferably 2 Pa to 80 kPa. For example, the material sheet can be heated in air (atmosphere). The partial pressure of oxygen in an ambient temperature atmosphere is 20 kPa.

Since the material sheet went through a rolling step at the time of manufacturing therefor, it has a residual stress. However, the heating step as in the above reduces the residual stress. Also, since the heating step proceeds with the oxidation of the stainless steel foil, in a later step, a deformation of the substrate based on the oxidation of the stainless steel foil is rarely caused.

The heating of the material sheet is preferably carried out under a temperature of 400° C. or more and 1000° C. or less, and further preferably 500° C. or more and 900° C. or less. The heating temperature of the material sheet of below 400° C. may not achieve the metal-oxide containing substrate with sufficient resistance to a high-temperature, oxidizing atmosphere. Additionally, in view of reducing the internal residual stress, and to securely preventing the deformation of the substrate in the heating step in the later, the heating temperature is preferably 400° C. or more. On the other hand, when the heating temperature of the material sheet is over 1000° C., the substrate may melt and the oxidation may proceed excessively, rendering the substrate brittle.

In the case of a thin material sheet (for example, a thickness of below 50 μm), the heating of the material sheet is preferably carried out while applying a tension to the material sheet. When the material sheet is heated without applying a tension, the substrate may deform due to the residual stress of the material sheet. On the other hand, by heating the material sheet while applying a tension to the material sheet, the deformation of the substrate as mentioned above can be prevented securely. The tension to be applied is preferably changed following the changes in size of the material sheet while being heated. For example, the heating is preferably carried out with a weight being hanged on one end of the material sheet in the rolling direction and the other end fixed, so that a tension is constantly applied to the rolling direction at the time of manufacturing process of the material sheet.

The thickness of the material sheet may be selected based on the desired thickness of the metal-oxide containing substrate. For example, in order to obtain a metal-oxide containing substrate with a thickness of 200 μm or less, a material sheet having almost the same thickness, i.e., a thickness of 200 μm or less, may be used.

A ceramic layer is preferably further provided on the surface of the metal-oxide containing substrate of the present invention. For an oxide forming the ceramic layer, a silicon oxide, an aluminum oxide, a zirconium oxide, and a titanium oxide may be mentioned. A composite oxide of two or more selected from silicon, aluminum, zirconium, and titanium may also be used. For the ceramic layer, phosphorus, boron or the like may be doped.

The ceramic layer plays a role to prevent a reaction between the metal-oxide containing substrate and a thin film to be formed on the substrate in the later step. The thickness of the ceramic layer for example is preferably 0.05 to 5 μm. An excessively thick ceramic layer renders the thickness of the substrate thick as well, and is disadvantageous in view of obtaining a thin substrate. On the other hand, an excessively thin oxide layer may not achieve the effect of preventing the reaction between the metal-oxide containing substrate and the thin film formed thereon at high temperatures.

The ceramic layer may be formed by a resistance-heating deposition method, an electron-beam heating deposition method, a sputtering method, a sol-gel method, a pulse laser deposition method, an ion plating method, or a CVD method. Two or more of these methods may be combined to form an oxide layer. In view of economies of mass production and cost reduction, the sol-gel method is the most preferable. Also, in view of increasing the smoothness of the substrate surface, the sol-gel method is advantageous.

Next, a case is described in which a thin film battery as an all-solid state battery is obtained by forming a power generating element as an example of a thin film device on the metal-oxide containing substrate of the present invention. In order to obtain a thin film battery which exerts a high voltage and has a high energy density, a thin film of a positive electrode has to be annealed under a high-temperature, oxidizing atmosphere, and therefore, the metal-oxide containing substrate of the present invention is suitably used.

First, a thin film as a positive electrode current collector is formed on a metal-oxide containing substrate of the present invention. For the positive electrode current collector, a material that will not be oxidized even though being exposed to a high-temperature, oxidizing atmosphere later on is preferable. For example, platinum, gold, an indium oxide, a tin oxide, and an indium oxide-tin oxide (ITO) are preferably used. On a portion of the substrate not heated at a high temperature, a thin film of titanium, chromium, cobalt, copper, iron, and aluminum may be formed. Formation of the thin film as the positive electrode current collector may be carried out by a sputtering method, a CVD method, a deposition method, a printing method, a printing-baking method, a sol-gel method, and a plating method.

On the positive electrode current collector, a thin film as a positive electrode is formed. In view of achieving a high energy density, as the positive electrode, a material with high crystallinity is preferably used. For example, lithium-containing transition metal oxides represented by lithium cobaltate (LiCoO₂), lithium nickelate (LiNiO₂), and lithium manganate (LiMn₂O₄); lithium-containing transition metal phosphate represented by lithium cobalt phosphate (LiCoPO₄), lithium nickel phosphate (LiNiPO₄), and lithium manganese phosphate (LiMnPO₄); and these compounds with a portion of the transition metal being replaced with other transition metal may be used. Next, to improve the crystallinity of the positive electrode thin film, for example, a heating process (annealing) is carried out in air. The thin film as the positive electrode may be formed by a sputtering method, a CVD method, a deposition method, a printing method, a printing-baking method, and a sol-gel method, but the sputtering method is preferable because the composition can be controlled relatively easily.

On the positive electrode, a thin film as a solid electrolyte is formed. For the solid electrolyte, an inorganic solid electrolyte is preferably used. For example, lithium phosphate oxynitride (LiₓPO_{y}N_{z}), lithium titanium phosphate (LiTi₂(PO₄)₃), lithium germanium phosphate (LiGe₂(PO₄)₃), Li₂O—SiO₂, Li₃PO₄—Li₄SiO₄, Li₂O—V₂O₅—SiO₂, Li₂O—P₂O₅—B₂O₃, Li₂O—GeO₂, Li₂S—SiS₂, Li₂S—GeS₂, Li₂S—GeS₂—Ga₂S₃, and Li₂S—P₂S₅, Li₂S—B₂S₃ may be used. Also to those compound mentioned above, a different element, halogenated lithium such as LiI, Li₃PO₄, LiPO₃, Li₄SiO₄, Li₂SiO₃, or LiBO₂ may be doped and used. Further, combinations of these may be used. The thin film as the solid electrolyte may be formed by a deposition method, a sputtering method, and a CVD method, but the sputtering method is preferable because the composition can be controlled relatively easily.

Also, a lithium salt may be dissolved in polyethylene oxide, polypropylene oxide, and ethylene oxide-propylene oxide copolymer to prepare a polymer solid electrolyte, and the polymer solid electrolyte may be applied on the positive electrode and dried, to make a thin film as a solid electrolyte.

On the solid electrolyte, a thin film as a negative electrode is formed. For the negative electrode, for example, metallic lithium, lithium alloy, aluminum, indium, tin, antimony, lead, silicon, lithium nitride, Li_{2.6}Co_{0.4}N, Li_{4.4}Si, lithium titanate, and carbon materials such as graphite may be used. The thin film as the negative electrode may be formed by a deposition method, a sputtering method, and a CVD method. However, for the formation of a thin film of metallic lithium, the deposition method is easy and preferable; for the formation of a thin film of an alloy and a compound, the sputtering method is preferable because the composition can be easily controlled; and for the formation of a thin film of a carbon material such as graphite, the CVD method is preferable.

On the negative electrode, a thin film as a negative electrode current collector is formed. The negative electrode current collector may be formed by the same method as the positive electrode current collector by using the same material. When the positive electrode is a lithium-containing compound, a step of forming the thin film as the negative electrode may be omitted. In that case, the negative electrode current collector is formed directly on the solid electrolyte, and metallic lithium is to be deposited on the negative electrode current collector. The deposited metallic lithium functions as the negative electrode.

A thin film battery is thus completed, but its outermost face is preferably covered with a sealing material. For the sealing material, for example, an epoxy resin, a polyethylene resin, a polypropylene resin, parylene, a liquid crystal polymer, glass, metal, or a composite of those may be used. For the sealing method of the thin film battery, an applying method, a CVD method, and a sputtering method may be used. Also, when a resin material is to be used, a thermosetting method, a pressure-molding method, and an injection molding method may be used.

In the following, the present invention is described in detail based on Examples with reference to the drawings, but the present invention is not limited thereto.

### EXAMPLE 1

A stainless steel foil with a thickness of 10 μm, a width of 20 mm, and a length of 40 mm was prepared as a material sheet. For the stainless steel, SUS304 (alloy including 18 wt % of Cr, 8 wt % of Ni, and the remaining portion substantially consisting of Fe) was used. The stainless steel foil was heated in air at 800° C. for 5 hours, to obtain a desired metal-oxide containing substrate.

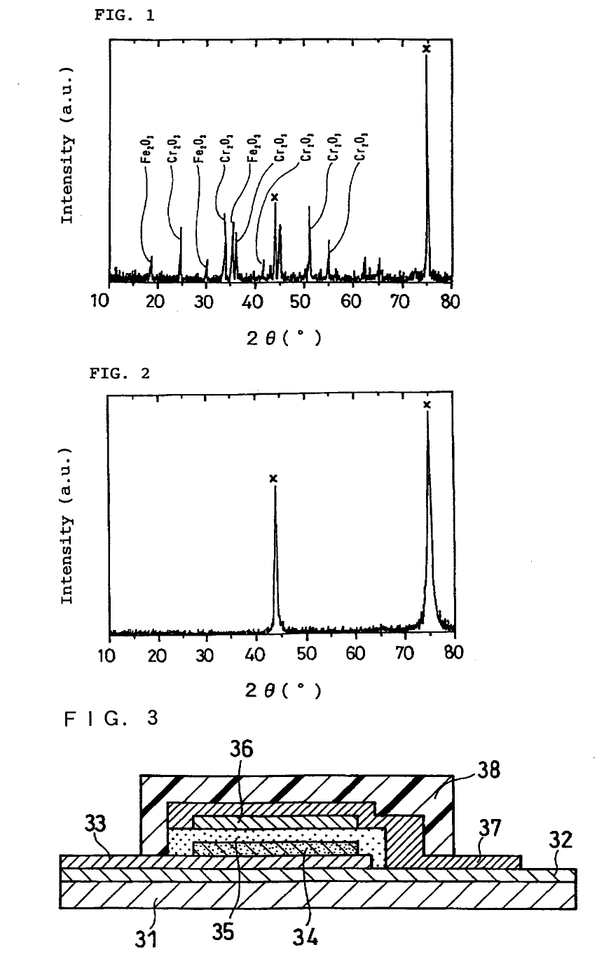

FIG. 1 shows an X-ray diffraction pattern obtained by an analysis of the metal-oxide containing substrate after the heating process in the form of the substrate as it is with a powder X-ray diffraction device. FIG. 2 shows an X-ray diffraction pattern of the material sheet before the heating process. In FIG. 2, peaks attributed only to SUS304 are observed in the proximity of 2θ=44° and 75°. On the other hand, in FIG. 1, many clear peaks attributed to Fe₂O₃ and Cr₂O₃ are observed.

In FIG. 1, the peak observed in the proximity of 2θ=75° is the maximum peak attributed to SUS304 in metal state, and the peak observed in the proximity of 2θ=51° is the maximum peak attributed to an oxide. Here, the maximum peak intensity attributed to an oxide is 30% of the maximum peak intensity attributed to the element in metal state.

When an XPS analysis was carried out in the depth direction while the obtained metal-oxide containing substrate was being etched, peaks attributed to Fe₂O₃ and Cr₂O₃ were confirmed even after passing the depth of 1 μm. On the other hand, when the material sheet was analyzed in the same manner, a peak of an oxide was detected at the outermost surface before carrying out the etching, but once the etching was started, the peak of the oxide disappeared suddenly.

On the material sheet and on the obtained metal-oxide containing substrate, a platinum thin film with a thickness of 1 μm was formed by a sputtering method. Then, each of the material sheet having the platinum thin film and the metal-oxide containing substrate having the platinum thin film was heated in air at 800° C. for 5 hours.

As a result, warpage occurred in the material sheet having the platinum thin film, with its face carrying the platinum thin film being outside. On the other hand, in the metal-oxide containing substrate having the platinum thin film, no warpage occurred, and its initial form was kept. However, when the sheet resistance of the platinum thin film was measured, even in the platinum thin film formed on the metal-oxide containing substrate, a certain decline in electron conductivity was confirmed.

Additionally, with a glass-made round rod having a diameter of 10 mm, a center portion of the metal-oxide containing substrate was held, and the substrate was bent in a direction of 90° and of 180°: but the substrate did not break. Then, when the substrate was released, its appearance was restored to the initial, flat form, indicating that a similar degree of flexibility with the material sheet was kept.

### EXAMPLE 2

A stainless steel foil with a thickness of 10 μm, a width of 20 mm, and a length of 40 mm was prepared as a material sheet. For the stainless steel, SUS304 (alloy including 19 wt % of Cr, 9.5 wt % of Ni, and the remaining portion substantially consisting of Fe) was used. The stainless steel foil was heated in air at 800° C. for 5 hours, to obtain a target metal-oxide containing substrate.

On the material sheet and on the obtained metal-oxide containing substrate, a xylene solution of perhydro polysilazane (inorganic polymer having a unit structure of —(SiH₂NH)ₙ—) (manufactured by Clariant) was applied and dried. Then, each of the material sheet having the dried film and the metal-oxide containing substrate having the dried film was heated in air at 450° C. for 30 minutes. As a result, on the metal-oxide containing substrate and on the material sheet, a silicon oxide (SiO₂) film with a thickness of 1 μm was formed.

Each of the material sheet having the silicon oxide film and the metal-oxide containing substrate having the silicon oxide film was heated in air at 800° C. for 5 hours. As a result, in the material sheet having the silicon oxide film, the surface became wavy, and its shape was significantly changed. On the other hand, the metal-oxide containing substrate having the silicon oxide film kept its initial form.

### EXAMPLE 3

A stainless steel foil with a thickness of 10 μm, a width of 20 mm, and a length of 40 mm was prepared as a material sheet. For the stainless steel, SUS304 (alloy including 19 wt % of Cr, 9.5 wt % of Ni, and the remaining portion substantially consisting of Fe) was used. The stainless steel foil was heated in air at 800° C. for 5 hours, to obtain a target metal-oxide containing substrate.

On each of the material sheet and the obtained metal-oxide containing substrate, a raw material sol of alumina was applied and dried. Here, as the raw material sol, a solution mixture in which nitric acid as a catalyst was added to an ethanol solution of aluminum isopropoxide was used. Then, each of the material sheet having the dried film and the metal-oxide containing substrate having the dried film was heated in air at 500° C. for 30 minutes. As a result, on each of the material sheet and the metal-oxide containing substrate, an aluminum oxide (Al₂O₃) film with a thickness of 1 μm was formed.

Each of the material sheet having the aluminum oxide film and the metal-oxide containing substrate having the aluminum oxide film was heated in air at 800° C. for 5 hours. As a result, in the material sheet having the aluminum oxide film, the surface became wavy, and its shape was significantly changed. On the other hand, the metal-oxide containing substrate having the aluminum oxide film kept its initial form.

### EXAMPLE 4

A stainless steel foil with a thickness of 10 μm, a width of 20 mm, and a length of 40 mm was prepared as a material sheet. For the stainless steel, SUS304 (alloy including 19 wt % of Cr, 9.5 wt % of Ni, and the remaining portion substantially consisting of Fe) was used. The stainless steel foil was heated in air at 800° C. for 5 hours, to obtain a target metal-oxide containing substrate.

On the material sheet and the obtained metal-oxide containing substrate, a raw material sol of zirconia was applied and dried. Here, as the raw material sol, a solution mixture in which nitric acid as a catalyst was added to an ethanol solution of zirconium isopropoxide was used. Then, each of the material sheet having the dried film and the metal-oxide containing substrate having the dried film was heated in air at 500° C. for 30 minutes. As a result, on the material sheet and on the metal-oxide containing substrate, a zirconium oxide (ZrO₂) film with a thickness of 1 μm was formed.

Each of the material sheet having the zirconium oxide film and the metal-oxide containing substrate having the zirconium oxide film was heated in air at 800° C. for 5 hours. As a result, in the material sheet having the zirconium oxide film, the surface became wavy, and its shape was significantly changed. On the other hand, the metal-oxide containing substrate having the zirconium oxide film kept its initial form.

### EXAMPLE 5

On the metal-oxide containing substrate having the silicon oxide film obtained in Example 2, a platinum thin film with a thickness of 1 μm was formed by a sputtering method. Afterwards, when the metal-oxide containing substrate having the silicon oxide film and the platinum thin film was heated in air at 800° C. for 5 hours, no warpage occurred in the substrate, and its initial form was kept. Additionally, when the sheet resistance of the platinum thin film was measured, it was found that the resistance value was 2Ω, and the platinum thin film kept appropriate electron conductivity.

### EXAMPLE 6

On the metal-oxide containing substrate having the aluminum oxide film obtained in Example 3, a platinum thin film with a thickness of 1 μm was formed by a sputtering method. Afterwards, when the metal-oxide containing substrate having the aluminum oxide film and the platinum thin film was heated in air at 800° C. for 5 hours, no warpage occurred in the substrate, and its initial form was kept. Additionally, when the sheet resistance of the platinum thin film was measured, it was found that the resistance value was 2Ω, and the platinum thin film kept appropriate electron conductivity.

### EXAMPLE 7

On the metal-oxide containing substrate having the zirconium oxide film obtained in Example 4, a platinum thin film with a thickness of 1 μm was formed by a sputtering method. Afterwards, when the metal-oxide containing substrate having the zirconium oxide film and the platinum thin film was heated in air at 800° C. for 5 hours, no warpage occurred in the substrate, and its initial form was kept. Additionally, when the sheet resistance of the platinum thin film was measured, it was found that the resistance value was 2Ω and that the platinum thin film kept appropriate electron conductivity.

### EXAMPLE 8

A stainless steel foil with a thickness of 10 μm, a width of 20 mm, and a length of 40 mm was prepared as a material sheet. For the stainless steel, SUS304 (alloy including 19 wt % of Cr, 9.5 wt % of Ni, and the remaining portion substantially consisting of Fe) was used. The stainless steel foil was heated in air at 800° C. for 5 hours, while applying a tension of 500 MPa constantly in the length direction to the stainless steel foil, (that is, the rolling direction at the time of manufacturing the material sheet), to obtain a target metal-oxide containing substrate.

When the tension of 500 MPa was applied to the material sheet, 97 sheets out of 100 sheets of the metal-oxide containing substrates kept the material sheet shape and involved no deformation. On the other hand, in the case when the material sheet was heated without applying a tension to the material sheet, in the 52 sheets out of 100 sheets, warpage and twisting occurred in the metal-oxide containing substrate, showing the deformation from the material sheet shape.

### EXAMPLE 9

An all-solid state thin film battery as shown in FIG. 3 was made as in below.

A stainless steel foil with a thickness of 10 μm, a width of 20 mm, and a length of 40 mm was prepared as a material sheet. For the stainless steel, SUS304 (alloy including 19 wt % of Cr, 9.5 wt % of Ni, and the remaining portion substantially consisting of Fe) was used. The stainless steel foil was heated in air at 800° C. for 5 hours, while applying a tension of 500 MPa constantly in the length direction to the stainless steel foil, to obtain a target metal-oxide containing substrate 31.

On the obtained metal-oxide containing substrate 31, polysilazane was applied and dried. Then, the metal-oxide containing substrate 31 having the dried film was heated in air at 450° C. for 30 minutes. As a result, on the metal-oxide containing substrate 31, a silicon oxide film 32 with a thickness of 1 μm was formed.

On the obtained silicon oxide film 32, as a positive electrode current collector 33, a platinum thin film with a thickness of 1 μm was formed by a sputtering method.

Then, on the positive electrode current collector 33, by using LiCoO₂ as a target, a thin film of a positive electrode 34 with a thickness of 1 μm, a width of 10 mm, and a length of 10 mm was formed by a sputtering method. The obtained thin film was heated in air at 800° C. for 5 hours, to crystallize LiCoO₂.

On the positive electrode 34 after going through the crystallization step, by using lithium phosphate as a target, in a nitrogen atmosphere, a thin film of a solid electrolyte 35 with a thickness of 1.5 μm was formed by a sputtering method. At that time, the thin film of the positive electrode 34 was entirely covered with the thin film of the solid electrolyte 35.

On the obtained solid electrolyte 35, by using metallic lithium as the vaporization source, by a vacuum deposition method, a thin film of metallic lithium with a thickness of 1 μm was formed as a negative electrode 36. The size of the negative electrode 36 was made the same as that of the positive electrode 34, and the positive electrode 34 was faced with the negative electrode 36.

On the obtained negative electrode 36, as a negative electrode current collector 37, a platinum thin film with a thickness of 1 μm was formed by a sputtering method.

Lastly, exposing a portion of the positive electrode current collector 33 and the negative electrode current collector 37, the layered thin films as a whole were covered with an epoxy resin 38, and the epoxy resin 38 was cured by heating. An all-solid state thin film battery was thus obtained. During the manufacturing process of the thin film battery, no warpage and twisting was caused in the substrate and the battery.

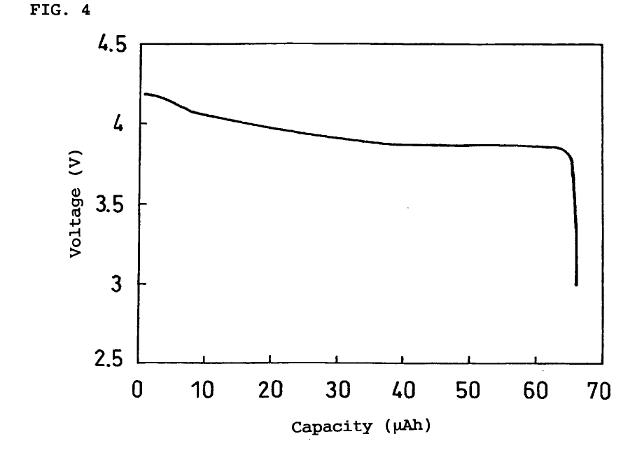

Charge and discharge characteristics of the obtained thin film battery were evaluated. To be specific, to the exposed portions of the positive electrode current collector 33 and the negative electrode current collector 37, external leads were connected, and the battery was charged until 4.2 V with a charging current of 15 μA, and was discharged until 3.0 V with a discharge current of 15 μA. FIG. 4 shows the relationships of the battery voltage and the capacity obtained at that time.

### COMPARATIVE EXAMPLE 1

A stainless steel foil with a thickness of 10 μm, a width of 20 mm, and a length of 40 mm was prepared as a material sheet. For the stainless steel, SUS304 (alloy including 19 wt % of Cr, 9.5 wt % of Ni, and the remaining portion substantially consisting of Fe) was used.

On the material sheet, polysilazane was applied and dried. Then, the material sheet having the dried film was heated in air at 450° C. for 30 minutes. As a result, on the material sheet, a silicon oxide film with a thickness of 1 μm was formed.

On the obtained silicon oxide film, a platinum thin film with a thickness of 1 μm was formed by a sputtering method as a positive electrode current collector. Then, on the positive electrode current collector, by using LiCoO₂ as a target, a thin film of the positive electrode with a thickness of 1 μm, a width of 10 mm, and a length of 10 mm was formed by a sputtering method.

The obtained thin film was heated in air at 800° C. for 5 hours to crystallize LiCoO₂, and at this point in time, warpage of the thin film battery was caused by the substrate.

### EXAMPLE 10

A stainless steel foil with a thickness of 10 μm, a width of 20 mm, and a length of 40 mm was prepared as a material sheet. For the stainless steel, SUS304 (alloy including 19 wt % of Cr, 9.5 wt % of Ni, and the remaining portion substantially consisting of Fe) was used. The stainless steel foil was heated in air at 800° C. for 5 hours without applying a tension to the stainless steel foil, to obtain a target metal-oxide containing substrate.

On the obtained metal-oxide containing substrate, polysilazane was applied and dried. Then, the metal-oxide containing substrate having the dried film was heated in air at 450° C. for 30 minutes. As a result, on the metal-oxide containing substrate, a silicon oxide film with a thickness of 1 μm was formed.

On the obtained silicon oxide film, as a positive electrode current collector, a platinum thin film with a thickness of 1 μm was formed by a sputtering method. Then, on the positive electrode current collector, by using LiCoO₂ as a target, a thin film of the positive electrode with a thickness of 1 μm, a width of 10 mm, and a length of 10 mm was formed by a sputtering method.

When the obtained thin film was heated in air at 800° C. for 5 hours to crystallize LiCoO₂, warpage was caused in the thin film battery by the substrate, but the degree of the warpage was very low compared with Comparative Example 1.

### EXAMPLE 11

The same operation as Example 1 was carried out, except that a material sheet comprising the stainless steel foil as listed below was used (a thickness of 10 μm, a width of 20 mm, and a length of 40 mm). That is, a predetermined stainless steel foil was heated in air at 800° C. for 5 hours, to obtain a target metal-oxide containing substrate.

Austenite-Type Stainless Steel Foil

SUS301, SUS301L, SUS630, SUS631, SUS302, SUS302B, SUSXM15J1, SUS303, SUS303Se, SUS304L, SUS304J1, SUS304J2, SUS305, SUS309S, SUS310S, SUS316, SUS16L, SUS321, and SUS347.

Ferrite-Type Stainless Steel Foil

SUH409, SUH409L, SUH21, SUS410L, SUS430F, SUS430LX, SUS430J1, SUS434, SUS436L, SUS444, SUS436J1L, SUSXM27, and SUS447J1.

Martensite-Type Stainless Steel Foil

SUS410S, SUS410F2, SUS416, SUS420J1, SUS420J2, SUS420F, SUS420F2, and SUS431.

Then, on the obtained metal-oxide containing substrate, a platinum thin film with a thickness of 1 μm was formed by a sputtering method. Then, the metal-oxide containing substrate having the platinum thin film was heated in air at 800° C. for 5 hours. As a result, in any of the metal-oxide containing substrate having the platinum thin film, no warpage occurred, and its initial form was kept.

Additionally, with a glass-made round rod having a diameter of 10 mm, a center portion of the metal-oxide containing substrate was held, and the substrate was bent in a direction of 90° and of 180°, but the substrate did not break. Then, when the substrate was released, its appearance was restored to the initial flat form, indicating that a similar degree of flexibility with the material sheet was kept.

### EXAMPLE 12

The same operation as Example 1 was carried out, except that the heating temperature of the material sheet was changed. That is, a stainless steel foil (SUS304 with a thickness of 10 μm, a width of 20 mm, and a length of 40 mm) was heated in air at 300 to 1200° C. for 1 to 48 hours, to obtain a target metal-oxide containing substrate. The ratio of the maximum peak intensity attributed to an oxide to the maximum peak intensity attributed to an element in metal state (%), and the relationships between heating temperatures and heating time are shown in Table 1.

TABLE 1

| | | Heating Time (hour) | | | | | |
|---|---|---|---|---|---|---|---|
| | | 1 | 2 | 5 | 12 | 24 | 48 |
| Heating | 300 | Not | Not | Not | Not | Not | 1% |
| Temperature | | Detected | Detected | Detected | Detected | Detected | |
| (° C.) | 400 | Not | Not | Not | Not | 2% | 3% |
| | | Detected | Detected | Detected | Detected | | |
| | 500 | Not | Not | 3% | 5% | 7% | 10% |
| | | Detected | Detected | | | | |
| | 600 | Not | 5% | 9% | 15% | 20% | 25% |
| | | Detected | | | | | |
| | 700 | 15% | 18% | 20% | 24% | 27% | 32% |
| | 800 | 20% | 26% | 30% | 35% | 37% | 39% |
| | 900 | 25% | 30% | 50% | 95% | Broken | Broken |
| | 1000 | 35% | 95% | Broken | Broken | Broken | Broken |
| | 1100 | 97% | Broken | Broken | Broken | Broken | Broken |
| | 1200 | Broken | Broken | Broken | Broken | Broken | Broken |

When the heating was carried out with a low temperature and for a long time, the oxidation of the material sheet did not proceed sufficiently, and the peak attributed to an oxide was not detected in an X-ray diffraction pattern. Such case is indicated as “Not Detected” in Table 1. Also, when the heating temperature was high, though the oxidation proceeded quite quickly, the mechanical strength of the substrate declined and the substrate was broken in some cases. Such case is indicated as “Broken” in Table 1. The results of Table 1 show that the most appropriate range of the heating temperature is 400° C. or more and 1000° C. or less, and preferably 500° C. or more and 900° C. or less.

### EXAMPLE 13

As material sheets, 100 sheets for each of a stainless steel foil with a thickness of 10 μm, 20 μm, 50 μm, 100 μm, or 200 μm, a width of 20 mm, and a length of 40 mm were prepared. For the stainless steel, SUS304 alloy (alloy including 18 wt % of Cr, 8 wt % of Ni, and the remaining portion substantially consisting of Fe) was used.

The stainless steel foil was heated in air at 500° C. for 24 hours, and cooled down to an ambient temperature. Afterwards, the stainless steel foil was heated in air at 800° C. for 5 hours, and the degree of deformation on the substrate was checked. The degree of the substrate deformation was shown as “(number of the substrate with no deformation)/100 (number of all substrate)”.

Additionally, for comparison, with respect to the material sheet with no heating process at 500° C. for 24 hours, the heating in air at 800° C. for 5 hours was carried out, and the degree of the substrate deformation was checked. The results are shown in Table 2.

TABLE 2

| | | Material Sheet Thickness (μm) | | | | |
|---|---|---|---|---|---|---|
| | | 10 | 20 | 50 | 100 | 200 |
| Heating | NO | 52/100 | 58/100 | 68/100 | 79/100 | 88/100 |
| Process | YES | 66/100 | 72/100 | 95/100 | 98/100 | 100/100 |
| at 500° C. | | | | | | |
| for 24 | | | | | | |
| hours | | | | | | |

As shown in the above, even the thin material sheet with a thickness of 20 μm or less, by the heating process with 500° C. for making it into a metal-oxide containing substrate, about the same yield as the material sheet with a thickness of 50 μm or more without the heating process at 500° C. can be obtained. Also, it is shown that when the material sheet with a thickness of 50 μm or more was heat-processed at 500° C. to form a metal-oxide containing substrate, the probability for the substrate deformation becomes quite low.

### EXAMPLE 14

As material sheets, 100 sheets for each of a stainless steel foil with a thickness of 10 μm, 20 μm, 50 μm, 100 μm, or 200 μm a width of 20 mm, and a length of 40 mm were prepared. For the stainless steel, SUS304 alloy (alloy including 18 wt % of Cr, 8 wt % of Ni, and the remaining portion substantially consisting of Fe) was used.

The stainless steel foil was heated in air at 500° C. by adjusting time period, and a substrate having a predetermined powder X-ray diffraction pattern was obtained.

Here, a metal-oxide containing substrate having the following diffraction patterns was made: the substrate having the ratio of the maximum peak intensity attributed to an element in metal state to the maximum peak intensity attributed to an oxide (maximum peak intensity ratio) of 3%, 5%, 10%, 25%, 50%, 90%, 95%, and 100%.

Afterwards, the metal-oxide containing substrate was heated in air at 800° C. for 5 hours, and the degree of the substrate deformation was evaluated in the same manner as Example 13 with “(number of the substrate with no deformation)/100 (number of all substrate)”.

Additionally, for comparison, with respect to the material sheet without the heating process at 500° C. as well, the heating was carried out in air at 800° C. for 5 hours, and the degree of the substrate deformation was checked. The maximum peak intensity ratio at this time was set to 0%. The results are shown in Table 3.

TABLE 3

| | | Substrate Thickness (μm) | | | | |
|---|---|---|---|---|---|---|
| | | 10 | 20 | 50 | 100 | 200 |
| Maximum | 0 | 52/100 | 58/100 | 68/100 | 79/100 | 88/100 |
| Peak | 3 | 60/100 | 63/100 | 79/100 | 83/100 | 87/100 |
| Intensity | 5 | 64/100 | 70/100 | 94/100 | 96/100 | 99/100 |
| Ratio (%) | 10 | 71/100 | 76/100 | 100/100 | 100/100 | 100/100 |
| | 25 | 77/100 | 84/100 | 100/100 | 100/100 | 100/100 |
| | 50 | 83/100 | 87/100 | 100/100 | 100/100 | 100/100 |
| | 90 | 80/100 | 83/100 | 100/100 | 100/100 | 100/100 |
| | 95 | 77/100 | 79/100 | 98/100 | 97/100 | 100/100 |
| | 100 | Broken | Broken | 83/100 | 87/100 | 91/100 |

The results in Table 3 show that the degree of the oxidation is preferable when the maximum peak intensity ratio is 3% or more and 95% or less. However, even though the oxidation proceeded to the outside of this range, when the thickness of the substrate is large, the metal-oxide containing substrate excellent in resistance to a high-temperature, oxidizing atmosphere can be obtained. Additionally, even with a low degree of oxidation, the effects can be obtained to a certain degree.

### EXAMPLE 15

A stainless steel foil with a thickness of 10 μm, a width of 20 mm, and a length of 40 mm was prepared as a material sheet. For the stainless steel, SUS304 alloy (alloy including 18 wt % of Cr, 8 wt % of Ni, and the remaining portion substantially consisting of Fe) was used.

The stainless steel foil was heated in air at 500° C. for 24 hours, or heated at 800° C. for 5 hours and cooled to an ambient temperature. Upon heating, to the length direction of the material sheet, a tension of 10 MPa, 20 MPa, 50 MPa, 100 MPa, 300 MPa, 500 MPa, 700 MPa, 1000 MPa, 1500 MPa, 1700 MPa, or 2000 MPa was applied.

Afterwards, the metal-oxide containing substrate was heated in air at 800° C. for 5 hours, and the degree of the substrate deformation was evaluated in the same manner as Example 13 with “(number of the substrate with no deformation)/100 (number of all substrate)”.

Additionally, for comparison, with respect to the material sheet with the heat process without the application of a tension in air at 500° C. for 24 hours, or at 800° C. for 5 hours, the heating was carried out in air at 800° C. for 5 hours, and the degree of the substrate deformation was checked. The tension at this time was set as 0 MPa. The results are shown in Table 4.

TABLE 4

| | Applied Tension (MPa) | | | | | |
|---|---|---|---|---|---|---|
| | 0 | 10 | 20 | 50 | 100 | 300 |
| 500° C. | 52/100 | 54/100 | 53/100 | 55/100 | 58/100 | 63/100 |
| 24 hours | | | | | | |
| 800° C. | 70/100 | 72/100 | 73/100 | 73/100 | 72/100 | 77/100 |
| 5 hours | | | | | | |

| | Applied Tension (MPa) | | | | | |
|---|---|---|---|---|---|---|
| | 500 | 700 | 1000 | 1500 | 1700 | 2000 |
| 500° C. | 72/100 | 74/100 | 77/100 | 77/100 | Fractured | Fractured |
| 24 hours | | | | | | |
| 800° C. | 84/100 | 83/100 | 87/100 | 86/100 | Fractured | Fractured |
| 5 hours | | | | | | |

The results of Table 4 show that when the tension is below 500 MPa, the substrate deformation occurred quite often, and when the tension is over 1500 MPa, a fracture of the material sheet is possibly caused. Therefore, it is shown that when the remarkable improvement in yield is to be expected, setting the tension to 500 MPa or more and 1500 MPa or less is effective.

### INDUSTRIAL APPLICABILITY

The metal-oxide containing substrate of the present invention is greatly resistant to a high-temperature, oxidizing atmosphere, and thus suitable for applications which involves annealing under a high-temperature, oxidizing atmosphere. The metal-oxide containing substrate of the present invention is excellent in dimensional stability or shape stability, thus hardly causing deformations such as twisting and warpage, and a separation of the thin film carried on the substrate is hardly caused. The present invention also contributes to downsizing and thinning of a thin film device and appliances to which the thin film device is to be mounted.

1. A metal-oxide containing substrate comprising:
an alloy including Fe and Cr and including at least one selected from the group consisting of Ni, Mo, Mn, Al and Si; and
an oxide of a metal element forming said alloy,
wherein said oxide exists at a depth of 1 μm from a surface of said substrate,
a Cr content relative to a total of all metal elements included in said substrate is 12 wt % or more and 32 wt % or less,
a total content of the metal elements excluding Fe and Cr relative to the total of all metal elements included in said substrate is 0.01 wt % or more and 20 wt % or less, and
a powder X-ray diffraction pattern of said substrate observed by using Cu Kα radiation has at least one peak attributed to said oxide.

2. (canceled)

3. The metal-oxide containing substrate in accordance with claim 1, wherein said oxide includes an oxide of Fe and an oxide of Cr.

4. (canceled)

5. The substrate in accordance with claim 1, wherein said Cr content is 16 wt % or more and 20 wt % or less.

6. The metal-oxide containing substrate in accordance with claim 1, wherein a ceramic layer is formed on said surface of said substrate.

7. The metal-oxide containing substrate in accordance with claim 6, wherein said ceramic layer comprises at least one selected from the group consisting of a silicon oxide, an aluminum oxide, and a zirconium oxide.

8. A method for manufacturing a metal-oxide containing substrate, the method comprising the steps of:
heating a material sheet comprising an alloy including Fe and Cr and including at least one selected from the group consisting of Ni, Mo, Mn, Al and Si, in an oxygen-existing atmosphere, to convert a portion of a metal element forming said alloy into an oxide, and
forming a ceramic layer on a surface of said substrate after said heating,
wherein a Cr content relative to a total of all metal elements included in said alloy is 12 wt % or more and 32 wt % or less; and
a total content of the metal elements excluding Fe and Cr relative to the total of all metal elements included in said alloy is 0.01 wt % or more and 20 wt % or less.

9. (canceled)

10. The method for manufacturing a metal-oxide containing substrate in accordance with claim 8, wherein said Cr content is 16 wt % or more and 20 wt % or less.

11. (canceled)

12. The method for manufacturing a metal-oxide containing substrate in accordance with claim 8, wherein said ceramic layer includes at least one selected from the group consisting of a silicon oxide, an aluminum oxide, and a zirconium oxide.

13. The method for manufacturing a metal-oxide containing substrate in accordance with claim 8, wherein said ceramic layer is formed by at least one method selected from the group consisting of a resistance-heating deposition method, an electron-beam deposition method, a sputtering method, a sol-gel method, a pulse laser deposition method, and an ion plating method.

14. The method for manufacturing a metal-oxide containing substrate in accordance with claim 8, wherein said heating is carried out while applying a tension to said material sheet.

15. The method for manufacturing a metal-oxide containing substrate in accordance with claim 14, wherein a direction of said tension is parallel to a rolling direction at the time of manufacturing said material sheet.

16. The method for manufacturing a metal-oxide containing substrate in accordance with claim 14, wherein said heating is carried out while said material sheet is being fixed with a jig so that a shape of said material sheet is kept.

17. An all-solid state battery comprising:
the metal-oxide containing substrate in accordance with claim 1; and
a power generating element formed on said substrate,
wherein said power generating element includes a positive electrode, a negative electrode, and a solid electrolyte interposed between said positive electrode and said negative electrode.

18. A metal-oxide containing substrate comprising:
an alloy including Fe and Cr and including at least one selected from the group consisting of Ni, Mo, Mn, Al and Si; and
an oxide of a metal element forming said alloy,
wherein a Cr content relative to a total of all metal elements included in said substrate is 12 wt % or more and 32 wt % or less,
a total content of the metal elements excluding Fe and Cr relative to the total of all metal elements included in said substrate is 0.01 wt % or more and 20 wt % or less, and
in peaks attributed to said oxide in a powder X-ray diffraction pattern of said substrate observed by using Cu Kα radiation, a maximum peak intensity is 3% or more and 95% or less of a maximum peak intensity in peaks attributed to the elements in metal state.

19. A method for manufacturing a metal-oxide containing substrate, the method comprising a step of:
heating a material sheet comprising an alloy including Fe and Cr and including at least one selected from the group consisting of Ni, Mo, Mn, Al and Si, in an oxygen-existing atmosphere, until an oxide is produced at a depth of 1 μm from a surface of said material sheet,
wherein a Cr content relative to a total of all metal elements included in said alloy is 12 wt % or more and 32 wt % or less, and
a total content of the metal elements excluding Fe and Cr relative to the total of all metal elements included in said alloy is 0.01 wt % or more and 20 wt % or less.
